(19) United States
(12) Patent Application Publication
(10) Pub. No.: US 2021/0403288 A1
(43) Pub. Date: Dec. 30, 2021

(54) ELEVATOR CARS

(71) Applicant: Otis Elevator Company, Farmington, CT (US)

(72) Inventors: Aurelien Fauconnet, Isdes (FR); Pascal Rebillard, Gien (FR); Gerard Sirigu, Gien (FR)

(21) Appl. No.: 16/950,995

(22) Filed: Nov. 18, 2020

(30) Foreign Application Priority Data
Jun. 26, 2020 (EP) 20305708.8

(51) Int. Cl. B66B 11/02; B66B 1/46; B66B 1/34; B66B 9/00; B66B 3/00; B66B 1/24

(52) U.S. Cl. CPC B66B 11/022; B66B 1/468; B66B 1/3461; B66B 11/0226; B66B 2201/4638; B66B 3/002; B66B 1/2416; B66B 2201/306; B66B 2201/4653; B66B 9/00

(57) ABSTRACT

An elevator car comprising a passenger cab and a robot cab, the robot cab is configured to accommodate at least one autonomous robot; wherein the robot cab includes: a robot cab controller configured to receive elevator call requests from the at least one autonomous robot and a coupling mechanism configured to couple the robot cab to the passenger cab.

### FOREIGN PRIORITY

This application claims priority to European Patent Application No. 20305708.8, filed Jun. 26, 2020, and all the benefits accruing therefrom under 35 U.S.C. § 119, the contents of which in its entirety are herein incorporated by reference.

### TECHNICAL FIELD

This disclosure relates to elevator cars for transporting autonomous robots, elevator systems including the elevator cars, and a method of operating the elevator cars.

### BACKGROUND

Robots are increasingly being used in high-rise buildings for many varied tasks, such as but not limited to transportation, cleaning and/or maintenance. To optimise the use of the robots, it is necessary to transport them safely between different floors of a building.

Elevators can be used as a means of moving robots between floors within a building. However, problems are encountered when human passengers and robots travel together in elevator cars. Therefore, elevator systems and methods have been developed to allow for passengers and robots to travel together in an elevator car in a safe manner Control systems have also been adapted to allow autonomous robots to call elevators as required, whilst not interfering with the smooth running of the elevator system and minimising impact on passenger travel.

The increasing use of autonomous robots, and the more complex nature of the infrastructure required for them to operate efficiently, has resulted in more design complexity for elevator systems and increasing safety concerns regarding passengers who may travel alongside the robots. The operation of elevator systems for transportation of passengers and robots in the same elevator car continues to result in a wide range of operational challenges.

### SUMMARY

According to a first aspect of the present disclosure there is provided an elevator car comprising a passenger cab and a robot cab, wherein the robot cab is configured to accommodate at least one autonomous robot; and wherein the robot cab comprises:

a robot cab controller configured to receive elevator call requests from the at least one autonomous robot and a coupling mechanism configured to couple the robot cab to the passenger cab.

The elevator car provides flexible transportation for both human and robot traffic. Further, since the robot cab is separate from the passenger cab and for exclusive use of autonomous robots, it can be adapted without having to take into account conventional safety and design restrictions which are required for human passengers. Therefore, the elevator car provides a safe, adaptable and smart working environment for autonomous robots.

The robot cab may be configured to accommodate one or more autonomous robots. The height of the robot cab may be configured to accommodate the height of the or each autonomous robot. The robot cab may have a height which is less than the height of the passenger cab. The height of the robot cab may be configured to accommodate the height of one or more types of autonomous robot.

The robot cab may be located above the passenger cab. The robot cab may be located below the passenger cab. The elevator car may include a plurality of robot cabs. The elevator car may include a plurality of robot cabs provided above and/or below the passenger cab, wherein each robot cab may be coupled to the passenger cab and/or another robot cab with a respective coupling mechanism.

The coupling mechanism may comprise one or more connectors configured to couple to one or more components of the passenger cab. The coupling mechanism may be configured to allow the robot cab to be retrofitted to an existing passenger cab. The coupling mechanism may be provided as part of a robot cab frame. The elevator car may comprise an elevator car frame which at least partially surrounds both the passenger cab and the robot cab. The coupling mechanism may be provided as part of the elevator car frame.

The coupling mechanism may comprise an adjustable coupling mechanism configured to adjust the vertical position of the robot cab with respect to the passenger cab.

The adjustable coupling mechanism may comprise a plurality of mechanical linkages. The adjustable coupling mechanism may comprise a pantograph arrangement. The adjustable coupling mechanism may be adjusted in order to vary the position of the robot cab with respect to the passenger cab. The adjustable coupling mechanism may be adjusted using a hydraulic system. The adjustable coupling mechanism may be adjusted using an electromechanical system.

The robot cab may comprise robot cab doors. The robot cab may comprise a robot door sill. The robot door sill may be configured to allow easy movement across the robot door sill by the autonomous robot. The robot door sill may be configured to at least partially overlay a landing door sill when the robot door sill and the landing door sill are in their deployed positions. The robot door sill may be configured to completely overlay a landing door sill when the robot door sill and the landing door sill are in their deployed positions. The robot door sill may be made of a durable material. The robot door sill may incorporate features (such as surface markings or tracks) to facilitate movement of the or each autonomous robot.

The robot cab may comprise a robot guidance system configured to interact with the or each autonomous robot. The robot guidance system may be configured to interact with corresponding guidance equipment provided on the robot. The robot guidance system may be a laser guidance system. The robot guidance system may comprise one or more markers. The robot guidance system may comprise at least one reflector mounted on an interior wall and/or a floor of the robot cab. The robot guidance system may comprise a plurality of reflectors mounted on interior walls of the robot cab. The robot guidance system may be configured to interact with a robot scanner provided on the autonomous robot. The robot scanner may be a laser scanner. The markers and/or reflectors may be configured to interact with the robot scanner to allow it to determine and adjust the autonomous robot's position within the robot cab.

The robot cab may comprise a charging hub configured to be used by the or each autonomous robot. The robot cab may comprise a data communications hub configured to be used by the or each autonomous robot.

The charging hub and the data communications hub may be provided as a single unit. The charging hub may be a wireless charging hub. The data communications hub may be configured to establish a wireless data link with the or each autonomous robot.

The robot cab may comprise a waste disposal unit configured to be used by the or each autonomous robot. The robot cab may comprise a refill station configured to be used by the or each autonomous robot. The waste disposal unit and the refill station may be provided as a single unit.

The robot cab may comprise a rotating floor section. The rotating floor section may be configured to be used by the ore each autonomous robot. The charging hub and/or the data communications hub may be provided on the rotating floor section.

The robot cab controller may be configured to receive robot elevator call requests from one or more autonomous robots.

According to a further aspect, there is provided an elevator system comprising: a hoistway; a plurality of landings with corresponding landing doors; the elevator car as described above; and an elevator controller; wherein the elevator controller is configured to operate the elevator car in response to elevator call requests from both passengers and autonomous robots.

The elevator controller may be configured to: receive passenger elevator call requests from one or more passengers; receive robot elevator call requests from one or more autonomous robots (via the robot cab controller); determine an elevator car journey plan in response to the received elevator call requests; and operate the elevator car based on the determined elevator car journey plan.

The robot cab controller may be configured to communicate with the elevator controller. The robot cab controller may be provided as an integral component of the elevator controller.

The elevator system may comprise at least one guide rail. The coupling mechanism may comprise at least one guide rail connector which is configured to engage with the at least one guide rail.

The robot cab may comprise robot cab doors, or a single robot cab door. The passenger cab may comprise passenger cab doors. The robot cab door(s) and the passenger cab doors may be provided on a first side of the elevator car. The passenger cab doors may be configured to remain closed when the robot cab doors are open. The robot cab door(s) and the passenger cab doors may be configured to open on the same side of the hoistway. The landing doors may comprise a first opening mechanism configured to engage with the passenger cab doors. The landing doors may comprise a second opening mechanism configured to engage with the robot cab door(s).

The robot cab doors may be provided on a first side of the elevator car and the passenger cab doors may be provided on a second side of the elevator car. At least one landing may comprise robot landing doors. The robot cab doors may be configured to engage with and open the robot landing doors. At least one landing may comprise passenger landing doors. The passenger cab doors may be configured to engage with and open the passenger landing doors.

The elevator system may comprise a passenger information system, configured to inform passengers of the activity of the robot cab. The passenger information system may be located in the passenger cab. The passenger information system may be located at one or more of the plurality of landings.

According to a further aspect, there is provided a method of controlling the elevator system as outlined above, the method comprising the steps of: a) receiving passenger elevator call requests from one or more passengers; b) receiving robot elevator call requests from one or more autonomous robots; c) determining an elevator car journey plan in response to the received elevator call requests; d) operating the elevator car based on the determined elevator car journey plan.

Step a) may include receiving passenger elevator call requests from one or more of: landing call panel(s), mobile personal device(s), elevator car call panel(s).

Step b) may include receiving elevator call requests from one or more autonomous robot waiting at a landing and/or one or more autonomous robot located within the robot cab. Step b) may include receiving elevator call requests which are predetermined based on a work schedule for the or each autonomous robot.

If no passenger elevator call requests are received, step c) may comprise determining that the elevator car journey plan will be set to a default setting. If no passenger or robot elevator call requests are received, step c) may comprise determining that the elevator car journey plan will be set to a default setting.

If elevator call requests are received from only autonomous robot(s), step c) may include one or more of the following: evaluating a robot action for the or each autonomous robot, based on whether the robot elevator call(s) relate(s) to one or more of: transport between landings, use of robot cab facilities and/or idle time; adapting the elevator car journey plan in accordance with the robot action(s).

When elevator call requests are received from both passengers and autonomous robot(s), step c) may include one or more of the following: evaluating a robot action for the or each autonomous robot, based on whether the robot elevator call request(s) relate(s) to one or more of: transport between landings, use of robot cab facilities, and idle time. determining a prioritisation strategy for passenger and robot travel based on the evaluated robot action; adapting the elevator car journey plan in accordance with the prioritisation strategy.

When elevator call requests are received from only autonomous robot(s), step d) may comprise one or more of the following: moving the elevator car to a sequence of one or more landings in accordance with the elevator car journey plan; accommodating the or each autonomous robot in the robot cab for the required time to complete use of the robot cab facilities and/or idle time; moving the elevator car so as to align the robot cab with a current landing of the or each autonomous robot, moving the elevator car so as to align the robot cab with a destination landing of the or each autonomous robot.

When elevator call requests are received from both passengers and autonomous robot(s), step d) may comprise one or more of the following: moving the elevator car to a sequence of one or more landings in accordance with the elevator car journey plan; accommodating the or each autonomous robot in the robot cab for the required time to complete use of the robot cab facilities and/or idle time; operating the passenger information system to inform passengers of activity relating to the autonomous robot(s); activating the adjustable coupling mechanism so as to align the robot cab with a landing above/or below the passenger cab.

### DRAWING DESCRIPTION

Certain preferred examples of this disclosure will now be described, by way of example only, with reference to the accompanying drawings, in which:

FIG. 1 shows a schematic illustration of an elevator system which may employ various examples of the present disclosure;

FIG. 2 shows an illustration of an elevator car according to an example of the present disclosure;

FIG. 3 shows a schematic illustration of an elevator car according to another example of the present disclosure;

FIG. 4A shows a side view schematic of a robot cab according to an example of the present disclosure;

FIG. 4B shows a schematic plan view of the robot cab of FIG. 4A; and

FIG. 5 shows a method of operating an elevator car according to an example of the present disclosure.

### DETAILED DESCRIPTION

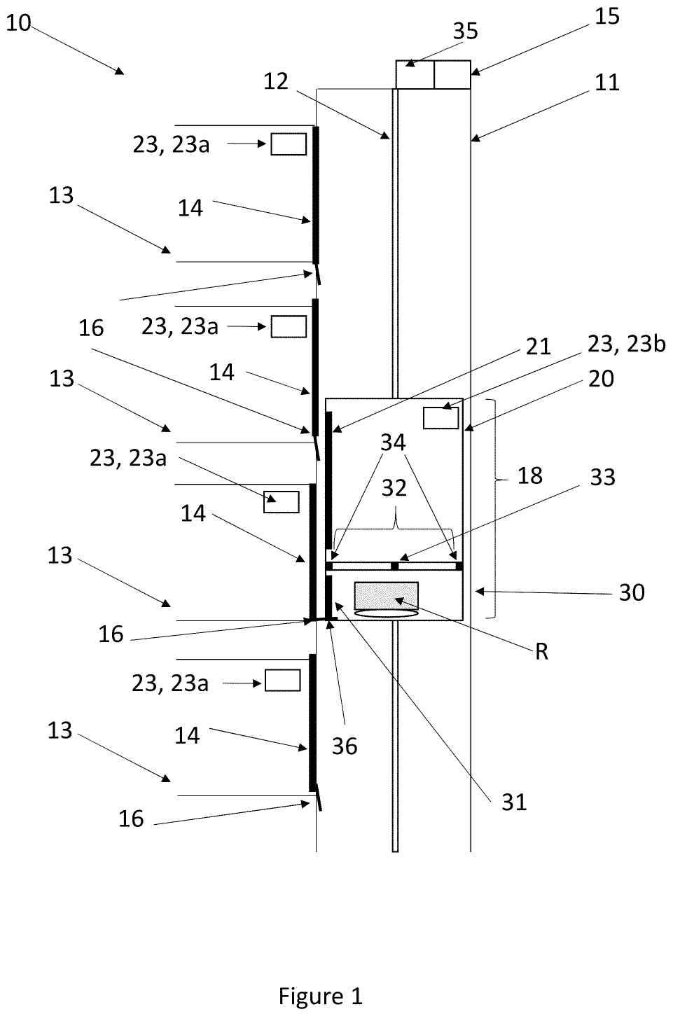

FIG. 1 is a schematic illustration of an elevator system 10 including a hoistway 11, a guide rail 12, a plurality of landings 13 each provided with a landing door 14, and an elevator controller 15. In the elevator hoistway 11 there is an elevator car 18 comprising a passenger cab 20 and a robot cab 30. The passenger cab 20 has passenger cab doors 21, and the robot cab 30 has robot cab doors 31. The landing doors 14 can be configured so as to engage and open with either the passenger cab doors 21 or the robot cab doors 31, but not for both at the same time. In the example shown in FIG. 1, with the robot cab 30 at one of the plurality of landings 13, the passenger cab 20 is not aligned with a landing 13. Therefore, the robot cab doors 31 will engage with the landing doors 14 and both the landing doors 14 and robot cab doors 31 will open, but the passenger cab doors 21 will remain closed for the safety of the passengers. The robot cab 30 includes a robot door sill 36, and at each landing 13 there is a landing door sill 16. The landing door sill 16 at the landing 13 with which the robot cab 30 is aligned is shown in a deployed position. The other landing doors sills 16 are in a stored position.

No drive mechanism is shown in the example given in FIG. 1. A person skilled in the art will appreciate that the implementation of the examples of the invention as described are not dependent on the drive system, and any known elevator drive system could be implemented with the examples shown.

The robot cab 30 is a cab specifically designed with the use of one or more autonomous robots R in mind. In FIG. 1, a single autonomous robot R is schematically depicted. It will be appreciated that the term “autonomous robot” means a robot that performs behaviours or tasks with a high degree of autonomy, in particular a robot which has the autonomy to move around within a defined working environment in accordance with its programming, for example, but not limited to autonomous robots for cleaning, maintenance or delivery of goods and/or services.

The robot cab 30 is configured to accommodate the height requirements of any particular type or types of autonomous robot R. This generally means that the height of the robot cab 30 is less than a height of the passenger cab 20.

It is known that robot wheels wear conventional door sills considerably more quickly than normal use by human passengers. This can affect the functionality of the opening and closing of the robot cab doors 31 and/or the landing doors 14. In addition, some autonomous robots R may find it difficult to transverse sill arrangements in conventional elevator systems due to uneven thresholds and/or gaps between sills. Therefore, the robot door sill 36 is configured to facilitate the autonomous robot(s) R entering and exiting the robot cab 30. The robot door sill 36 is made with a durable material to withstand robot traffic, for example in the form of reinforcement. The robot door sill 36 at least partially overlays the landing door sill 16 when the two sills 16, 36 are in the deployed position. In another example (not shown) the robot door sill 36 completely covers the landing door sill 16 when the two sills 16, 36 are in the deployed positions.

In another example, the robot door sill 36 can be configured to be removeably coupled to the robot cab 30, which means that it can be easily replaced, for example when the wheels (or other transport) of the autonomous robot have worn the robot door sill 36 beyond acceptable limits.

In the example of FIG. 1, the robot cab 30 is coupled below the passenger cab 20 by a coupling mechanism 32, which in this example comprises two connectors 34. In FIG. 1, two connectors 34 are shown, the two connectors 34 coupling an upper portion of the robot cab 30 to a lower portion of the passenger cab 20. The two connectors 34 provide a rigid connection between the passenger cab 20 and the robot cab 30. Whilst two connectors 34 are depicted in FIG. 1, it will be appreciated that the coupling mechanism 32 may include a single connector 34 or any suitable number of connectors 34.

In another example (not shown) the or each connector 34 is provided as part of an elevator car frame which at least partially surrounds both the passenger cab 20 and the robot cab 30. In a further example (not shown), the or each connector 34 can be provided as part of a robot cab frame. The or each connector 34 may be configured to allow the robot cab 30 to be retrofitted to an existing passenger cab 20.

Whilst only one guide rail 12 is shown, it will be appreciated that a plurality of guide rails 12 are typically disposed on opposite sides of the hoistway 11. In FIG. 1 the passenger cab 20 and robot cab 30 are guided by the guide rail(s) 12. The coupling mechanism 32 includes at least one guide rail connector 33 which is disposed between the passenger cab 20 and the robot cab 30 for ensuring smooth connection to the guide rail(s) 12. The at least one guide rail connector 33 may be configured to engage with the guide rail(s) 12.

In this example, the robot cab 30 has its own dedicated robot cab controller 35, which can be positioned at any suitable location within or near the elevator system 10, but is shown in this example located with the elevator controller 15 on top of the hoistway 11. The controllers 15, 35 have a communication link between them, for example a wired or wireless connection. In another example (not shown) the robot cab controller 35 can be provided as an integral part of the elevator controller 15.

The elevator system 10 includes a passenger information system 23 which is configured to provide audio and/or visual information to the passengers relating to the transport of autonomous robot(s) R in the robot cab 30.

In the example of FIG. 1, the passenger information system 23 includes a landing information system 23a which provides information to passengers waiting on at least one of the plurality of landings 13 and a passenger cab information system 23b which provides information to passengers in the passenger cab 20. The landing information system 23a and the passenger cab information system 23b may provide audio and/or visual messages to the passengers.

The passenger information system 23 is used to relay information to passengers on one or more of the plurality of landings 13 and/or inside the passenger cab 20, for example to inform them that one or more autonomous robots R will be entering/exiting the robot cab 30, and to stay away from the landing doors 14 and the passenger cab doors 21 until the passenger cab 20 is at one of the plurality of landings 13.

The passenger information system 23 may be incorporated into landing control panels and/or passenger cab control panels. It will also be appreciated that the passenger information system 23 could be implemented in other ways and could easily be integrated with other elevator subsystems, for example, elevator applications on personal mobile devices, visual displays or audio systems.

FIG. 1 depicts an elevator system 10 with one hoistway 11 and a single elevator car 18. However, it will be appreciated that in elevator systems 10 comprising more than one hoistway 11, one or more elevator cars 18 as outlined above may be provided.

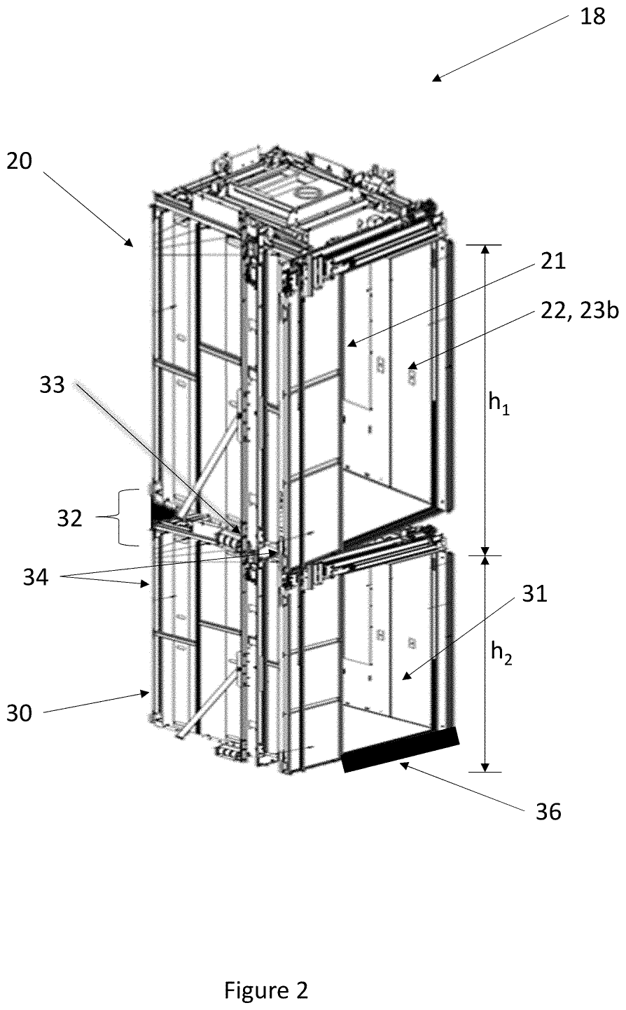

FIG. 2 shows another example of an elevator car 18. To simplify the figure, no autonomous robots R are depicted in FIG. 2.

The interior of the robot cab 30 is configured specifically for the type(s) of autonomous robot(s) R. Since no human passengers will travel in the robot cab 30, functional features (such as elevator call panels, bright lighting) and aesthetic/decorative features normally provided in elevator cabs for human passengers are not required. Therefore, the interior of the robot cab 30 is much plainer and simpler. In this example, the robot cab 30 has a height h₂ which is considerably shorter than a height h₁ of the passenger cab 20.

The coupling mechanism of FIG. 2 includes the connector 34, and the at least one guide rail connector 33. The coupling mechanism 32 ensures secure connection between the passenger cab 20 and the robot cab 30, and so that the two cabs 20, 30 move safely together in the hoistway 11. The robot doors 31 have a similar design to the passenger doors 31. The robot door sill 36 is provided below the robot doors 31.

The passenger cab 20 includes a passenger control panel 22 for displaying floor information and call information. The passenger cab information system 23b may be a separate system or may be integrated with the passenger control panel 22.

As discussed above, there is no control panel provided in the robot cab 30. Instead, the robot cab controller 35 is configured to establish a wireless connection with the autonomous robot R, for example to receive call requests and destination floor information.

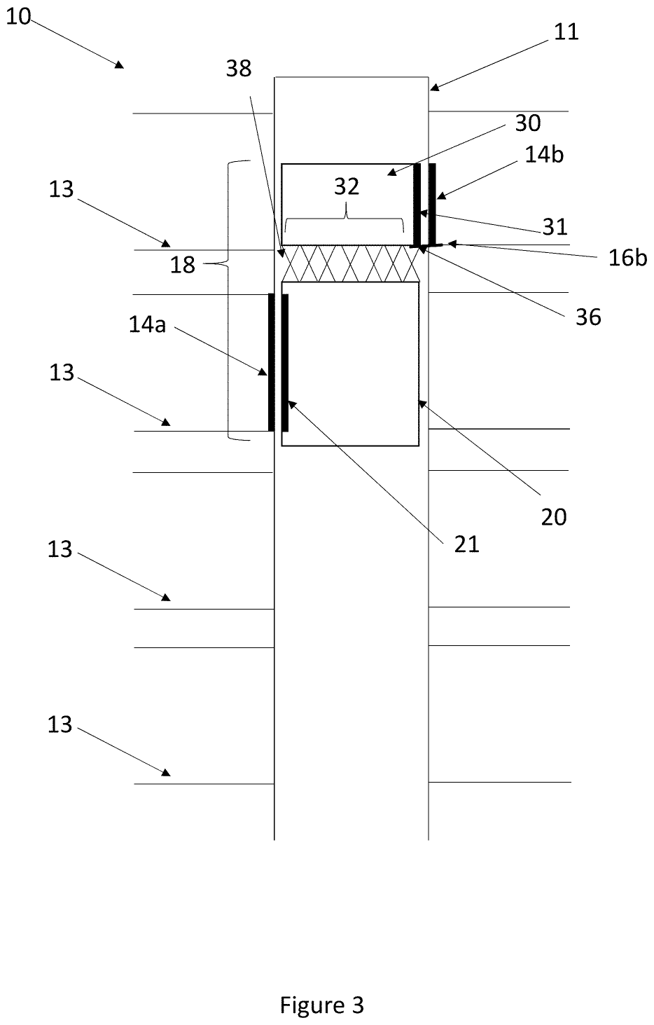

Another example of an elevator car 18 is shown in FIG. 3. In this example, the coupling mechanism 32 includes an adjustable coupling mechanism 38 which connects to an upper part of the passenger cab 20 and a lower part of the robot cab 30 such that the robot cab 30 is located above the passenger cab 20. The adjustable coupling mechanism 38 is configured to move the robot cab 30 vertically with respect to the passenger cab 20 to allow for a difference in distance between the plurality of landings 13, or so the robot cab 30 can align with a higher one of the plurality of landings 13 above the passenger cab 20. In FIG. 3, the adjustable coupling mechanism 38 comprises a mechanical linkage, which can be expanded and contracted in order to adjust its length, thereby moving the robot cab 30 vertically with respect to the passenger cab 20. The adjustable coupling mechanism 38 can be adjusted using any suitable actuator arrangement, such as but not limited to a hydraulic system or an electromechanical system. In another example (not shown) the mechanical linkage is provided as a pantograph arrangement which is controlled using hydraulics.

It will be appreciated that the adjustable coupling mechanism 38 could be provided to couple the robot cab 30 below the passenger cab 20.

In the example of FIG. 3, the robot cab 30 has robot cab doors 31 on the side of the elevator car 18 opposite to the passenger cab doors 21. This means that the robot cab doors 31 open on the opposite side of the hoistway 11 to the passenger cab doors 21. This configuration reduces the chance of interaction between the passenger(s) and the autonomous robot(s) R waiting a given landing 13. In this example, on a “robot side” of the hoistway 11 the robot landing doors 14b are smaller doors, which are configured to correspond to the size of the robot cab doors 31. On a “passenger side” of the hoistway 11, the passenger landing doors 14a are a standard size to correspond to the size of the passenger cab doors 21.

The robot landing doors 14b are provided with robot landing door sills 16b. The robot landing door sills 16b are made of durable material in order to withstand robot traffic.

With this arrangement of doors on the elevator car 18, the passenger cab 20 and robot cab 30 may be provided with separate landing door opening mechanisms (not shown) which are configured to open the respective landing doors 14a, 14b.

The passenger information system 23 may be adapted to give information about waiting time due to the robot cab 30 which the passengers may not be aware of, as there is no longer interaction between the passengers and the autonomous robot(s) R.

In another example (not shown), the robot cab 30 has robot cab doors 31 provided on a side of the elevator car 18 which is adjacent to the side on which the passenger cab doors 21 are provided. Robot landing doors 14b are provided on a corresponding side wall of the hoistway 11. This configuration also reduces the chance of interaction between the passenger(s) and the autonomous robot(s) R waiting at the plurality of landings 13.

It will be appreciated that whilst the robot cab 30 is described as having robot cab doors 31, the robot cab 30 could be provided with a single door 31.

In the examples described above, each elevator car 18 includes one robot cab 30 provided above or below the passenger cab 20. However, it will be appreciated that in other examples, elevator cars 18 may be provided with two or more robot cabs 30. For example, the elevator car 18 may include two or more robot cabs 30 located above the passenger cab 20, or the elevator car 18 may include one robot cab 30 above and one robot cab 30 below the passenger cab 20. Where multiple robot cabs 30 are provided, each robot cab 30 is coupled to the passenger cab 20 and/or another robot cab 30, with a coupling mechanism 32 depending on the arrangement of the robot cab(s) 30.

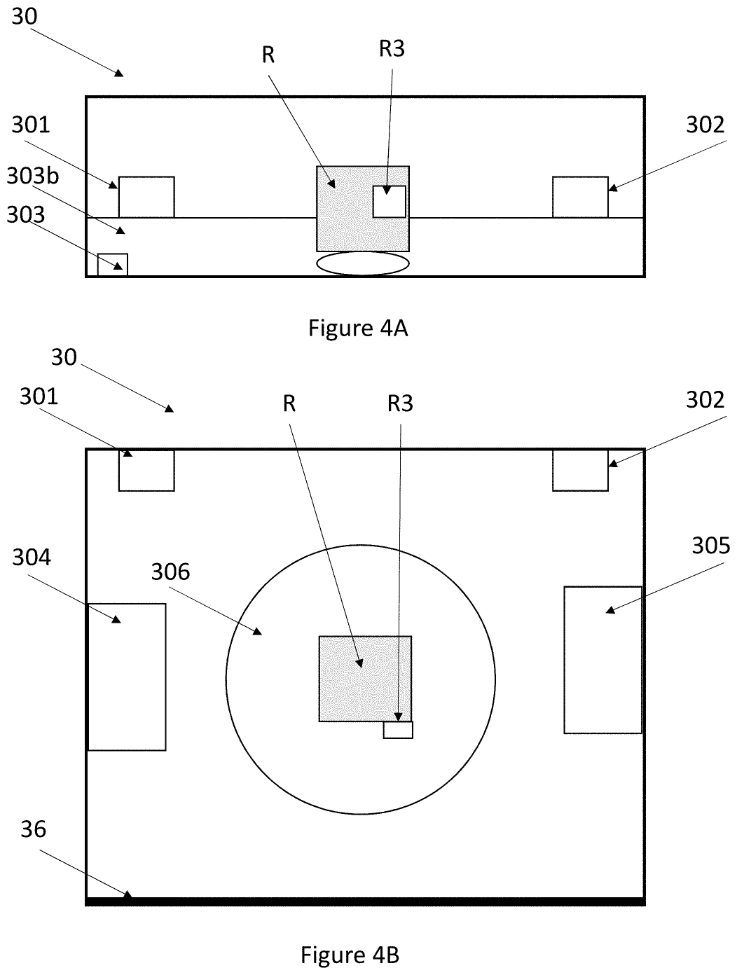

FIG. 4A shows a side view and FIG. 4B shows a plan view of an example of a robot cab 30 for transporting an autonomous robot R.

A robot guidance system 303 is shown in the robot cab 30. The robot guidance system 303 is configured to interact with corresponding guidance equipment provided on the autonomous robot R for accurate movement of the autonomous robot R into and out of the robot cab 30. The robot guidance system 303 can be used by the autonomous robot R to locate a specific location in the robot cab 30, for example a charging hub 302.

In FIGS. 4A and 4B, the robot guidance system 303 comprises a plurality of reflectors 303b (sometimes referred to as targets) mounted on interior walls of the robot cab 30. The autonomous robot R is provided with a laser scanner (or similar) R3, which uses the reflectors 303b to determine and adjust its position within the robot cab 30.

Such laser guidance systems may not be suitable for locations where passengers are found as passengers can provide interference and get in the way of reflectors 303b. However, the robot cab 30 for use only by the autonomous robot R can easily implement such a system. Whilst the example given here is a laser guidance system, any guidance system which may aid the movement of the autonomous robot R may be implemented, including for example an acoustic guidance system.

In addition, the robot cab 30 may include one more facilities 301, 302, 304, 305 which can be used by the autonomous robot R while it is located in the robot cab 30. Exemplary robot cab facilities are outlined below. However, it will be appreciated that the robot cab 30 can be adapted to incorporate a wide range of facilities.

In FIG. 4A and FIG. 4B, the robot cab 30 includes a data transmission facility 301, which is used for the transmission of data from the autonomous robot R to the robot cab controller 35 and/or the elevator controller 15. The data transmission facility 301 for example, a data communication hub 301, may be utilized for updating or bugging the programming of an autonomous robot R or retrieval of data such as maintenance data.

A charging hub 302 may be provided, the charging hub 302 being configured for the requirements of the autonomous robot R. The charging hub 302 may provide wired and/or wireless charging. Many autonomous robots have the ability to recognise their needs, for example when charging is required, and can therefore use the robot cab 30 as a moving charging station. The autonomous robot R can enter the robot cab 30 and begin charging whilst the elevator car 18 continues operation as usual for passengers. When the autonomous robot R is fully charged it can then communicate to the robot cab controller 35 at which floor it wishes to exit to continue its work. A similar implementation may be used if large data transfers to/from the autonomous robot R are required.

In an example where the autonomous robot R carries out cleaning and/or maintenance tasks, the inside of the robot cab 30 can be configured to include appropriate facilities, such as a waste disposal 304 and/or a refill station 305. By using the robot guidance system 303 the robot cab 30 the autonomous robot R can locate the waste disposal unit 304 or refill station 305 to autonomously retrieve and/or dispose of items in accordance with its operating requirements.

A rotating floor section 306 may be provided to aid with the movement of the autonomous robot R in and out of the robot cab 30, especially in a situation where complicated movement of the autonomous robot R inside the robot cab 30 is not possible, or the autonomous robot R has limited maneuverability. This enables the autonomous robot R to be facing the robot cab doors 31 before exiting and can reduce delays incurred when an autonomous robot R cannot quickly exit the robot cab 30.

It will be appreciated by those skilled in the art that the various features described inside the robot cab 30 may be found as separate features or as combined units, for example there may be a single unit which facilitates both charging and data transfer.

The robot facilities outlined above may be used whilst the autonomous robot R is moving between floors. Alternatively, the robot cab 30 can act as a rest area for an idle autonomous robot R, or as described above an autonomous robot R can use the robot cab 30 for certain activities and then provide an elevator call request outlining its desired destination to the robot cab controller 35 for onward travel.

This example shows a robot cab 30 designed for a single autonomous robot R. In additional examples (not shown) each robot cab 30 can be designed to house and transport multiple autonomous robots R between locations.

The robot cab 30 can have any combination of features shown in this example, or include additional features for one or more types of autonomous robot(s) R.

Whilst in the examples here the plan view of the hoistway 11 and the elevator car 18 is rectangular, it will be appreciated by those skilled in the art that modern elevator systems can be made with various different cross-sections, and be specially designed around the specific needs of modern buildings. The elevator system 10 and elevator car 18 described here can be adapted for use within various types of building elevator systems 10, depending on the requirements of the building and the type or types of autonomous robot(s) R.

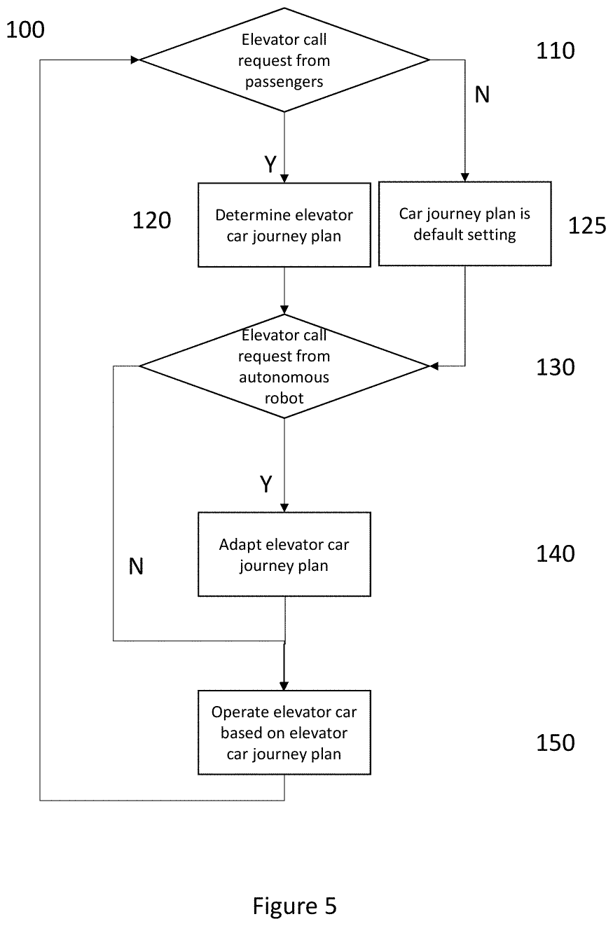

A method 100 of operating the elevator system 10 is schematically represented in FIG. 5.

In step 110, the elevator controller 15 monitors for elevator call request(s) from passengers. The passenger elevator call requests may be sent using any known devices, such as but not limited to from landing call panels, mobile user devices etc.

If one or more passenger elevator call requests are received, in step 120, the elevator controller 15 determines an elevator car journey plan based on the received passenger call requests.

In step 125, if no passenger elevator call requests are received, the elevator controller 15 determines that the elevator car journey plan will be set to a default setting. The default settings for the elevator car journey plan are predetermined, and the multiple default settings are dependent on operational parameters. For example, the default setting may be to relocate the elevator car 18 to a main lobby at given landing 13 at times when large passenger traffic is expected in the main lobby, or during periods of planned robot activity, the default setting may be to move the elevator car 18 to the landing 13 on a floor where the robot activity is taking place, such as when the robots are conducting cleaning of a building overnight or at weekends.

Once the elevator car journey plan is determined, the elevator controller 15 then monitors for elevator call request(s) from autonomous robots R in step 130. The robot elevator call request(s) may be received via the robot cab controller 35.

Robot elevator call requests may be received from autonomous robots R waiting at a landing 13 and/or autonomous robots R located within the robot cab 30. Robot elevator call requests may predetermined based on a work schedule for one or more autonomous robots R, for example, based on a cleaning schedule a predetermined robot elevator call request may be scheduled to move the autonomous cleaning robot(s) R between floors at specific given times.

In step 130, the elevator controller 15 may receive a robot elevator call request in the form of a data package from the or each autonomous robot R. The data package may include data relating to one or more of the following: a current location of the autonomous robot R; a requested destination of the autonomous robot R; an indication of any secondary activity to be carried out by the autonomous robot R; and request for idle time. Secondary activity to be carried out is understood to use of any facilities provided within the robot cab 30, such as but not limited to: charging, data transfer, retrieval and/or disposal of items.

In the situation where an autonomous robot R has previously entered the robot cab 30 for a purpose other than transportation to another landing 13, such as to use one of the facilities within the robot cab 30 or when the autonomous robot R has entered the robot cab 30 for idle time, the autonomous robot R may remain in the robot cab 30 for an extended period without transmitting a call request to travel to a specific destination.

If no robot elevator call requests are received, the elevator controller 15 operates the elevator car 18 in accordance with the determined elevator car journey plan in step 150.

If one or more robot elevator call requests are received, the elevator controller 15 adapts the elevator car journey plan accordingly in step 140.

When one or more elevator call requests are received from only autonomous robot(s) R, the step of adapting the elevator car journey plan may include one or more of the following: evaluating a robot action for the or each autonomous robot R, based on whether the robot elevator call request(s) relates to one or more of: transport between landings, use of robot cab facilities and idle time; adapting the elevator car journey plan in accordance with the robot action(s).

When elevator call requests are received from both passengers and autonomous robot(s) R, the step of adapting the elevator car journey plan may include one or more of the following: evaluating a robot action for the or each autonomous robot R, based on whether the robot elevator call request(s) relate(s) to one or more of: transport between landings, use of robot cab facilities and idle time. determining a prioritisation strategy for passenger travel and robot travel based on the evaluated robot action(s); adapting the elevator car journey plan in accordance with the prioritisation strategy.

In step 150, the elevator controller 15 then operates the elevator car 18 in accordance with the adapted elevator car journey plan.

When elevator call requests are received from only autonomous robot(s) R, the step of operating the elevator car 18 in accordance with an adapted elevator car journey plan may comprise one or more of the following: moving the elevator car 18 to a sequence of one or more landings 13 in accordance with the elevator car journey plan; accommodating the or each autonomous robot R in the robot cab 30 for the required time to complete use of the robot cab 30 facilities and/or idle time; moving the elevator car 18 so as to align the robot cab 30 to align with a current landing 13 of the autonomous robot R, moving the elevator car 18 so as to align the robot cab 30 to align with a destination landing 13 of the autonomous robot R.

When elevator call requests are received from both passengers and autonomous robot(s) R, the step of operating the elevator car 18 in accordance with an adapted elevator car journey plan may comprise one or more of the following: moving the elevator car 18 to a sequence of one or more landings 13 in accordance with the elevator car journey plan; accommodating the or each autonomous robot R in the robot cab 30 for the required time to complete use of the robot cab facilities and/or idle time; operating the passenger information system 23, 23a, 23b to inform passengers of activity of the autonomous robot R; activating the adjustable coupling mechanism 38 so as to align the robot cab 30 with a landing 13 above/or below the passenger cab 20.

During the elevator car journey, the elevator controller 15 may continue to monitor for elevator call requests, and if appropriate the elevator car journey plan may be further adapted during the run, for example to pick up extra passengers during the journey.

Once the elevator car journey has been completed, the elevator call requests are again monitored.

It will be appreciated that the exemplary method outlined above is a simplified representation of the method of operation in order to explain the examples of the current disclosure. In operation of an elevator system, the method steps outlined can be modified and adapted to incorporate other operational requirements (such as emergency override instruction), or the steps can be incorporated into existing operation method steps.

In elevator systems comprising more than one elevator car, one or more elevator cars as outlined above may be provided. In elevator systems having a plurality of elevator cars, where at least one elevator car is configured as outlined above, the controller may be configured to assign this elevator car only for the transportation of autonomous robots during periods of low demand from human passengers.

It will be appreciated by those skilled in the art that the disclosure has been illustrated by describing one or more specific aspects thereof, but is not limited to these aspects; many variations and modifications are possible, within the scope of the accompanying claims. The various embodiments shown have features which are interchangeable with each other depending on the system.

What is claimed is:

1. An elevator car (18) comprising a passenger cab (20) and a robot cab (30) wherein: the robot cab (30) is configured to accommodate at least one autonomous robot (R);
wherein the robot cab (30) comprises:
a robot cab controller (35) configured to receive elevator call requests from the at least one autonomous robot (R) and
a coupling mechanism (32) configured to couple the robot cab (30) to the passenger cab (20).

2. The elevator car (18) of claim 1, wherein the robot cab (30) is located above or below the passenger cab (20).

3. The elevator car (18) of claim 1, wherein the coupling mechanism (32) comprises an adjustable coupling mechanism (38) configured to adjust the vertical position of the robot cab (30) with respect to the passenger cab (20).

4. The elevator car (18) of claim 1, wherein the robot cab (30) comprises robot cab doors (31), and a robot door sill (36).

5. The elevator car (18) of claim 1, wherein the robot cab (30) comprises a robot guidance system (303) configured to interact with the at least one autonomous robot (R).

6. The elevator car (18) of claim 1, wherein the robot cab (30) comprises a charging hub (302) configured to be used by the autonomous robot (R) and/or a data communications hub (301) configured to be used by the at least one autonomous robot (R).

7. The elevator car (18) of claim 1, wherein the robot cab (30) comprises a waste disposal unit (304) configured to be used by the at least one autonomous robot (R) and/or a refill station (305) configured to be used by the at least one autonomous robot (R).

8. The elevator car (18) of claim 1 wherein the robot cab (30) comprises a rotating floor section (306)

9. An elevator system (10) comprising: a hoistway (11), a plurality of landings (13) with corresponding landing doors (14), the elevator car (18) of claim 1, and an elevator controller (15);
wherein the elevator controller (15) is configured to operate the elevator car (18) in response to elevator call requests from both passengers and the at least one autonomous robot (R).

10. The elevator system (10) of claim 9, comprising at least one guide rail (12), and wherein the coupling mechanism (32) comprises at least one guide rail connector (33) configured to engage with a corresponding guide rail (12).

11. The elevator system (10) of claim 9, comprising passenger cab doors (21) and robot cab doors (31); wherein the robot cab doors (31) and the passenger cab doors (21) are provided on a first side of the elevator car (18), and wherein the passenger cab doors (21) are configured to remain closed when the robot cab doors (31) are open.

12. The elevator system (10) of claim 9, comprising passenger cab doors (21) and robot cab doors (31); wherein the robot cab doors (31) are provided on a first side of the elevator car (18) and the passenger cab doors (21) are provided on a second side of the elevator car (18); and
wherein the at least one landing (13) comprises robot landing doors (14b) and passenger landing doors (14a), and
wherein the robot cab doors (31) are configured to engaged with and open the robot landing doors (14b); and passenger cab doors (21) are configured to engage with and open the passenger landing doors (14a).

13. The elevator system (10) of claim 9, comprising a passenger information system (23), configured to inform passengers of the activity of the robot cab (30).

14. A method of controlling the elevator system (10) according to claim 9, the method comprising the steps of:
a) receiving passenger elevator call requests from one or more passengers;
b) receiving a robot elevator call request from one or more autonomous robots (R);
c) determining an elevator car journey plan in response to the received elevator call requests;
d) operating the elevator car (18) based on the determined elevator car journey plan.

15. The method (100) according to claim 14, wherein step c) comprises one or more of the following:
evaluating a robot action for the one or more autonomous robots (R), based on whether the robot elevator call request(s) relate(s) to one or more of: transport between landings, use of robot cab facilities and idle time;
adapting the elevator car journey plan in accordance with the robot action(s).
